(19) United States
(12) Patent Application Publication
(10) Pub. No.: US 2004/0034969 A1
(43) Pub. Date: Feb. 26, 2004

(54) Cabinet hinge installable by one person

(76) Inventor: Thomas Wegman, Effingham, IL (US)

Correspondence Address: OLSON & HIERL, LTD., 36th Floor, 20 North Wacker Drive, Chicago, IL, 60606, US

(21) Appl. No.: 10/224,542

(22) Filed: Aug. 20, 2002

(51) Int. Cl. E05D 5/06

(52) U.S. Cl. 16/389

(57) ABSTRACT

A hinge and an associated method of use are provided that enable one person to hinge a cabinet door relative to a cabinet aperture. The hinge has first and second hinge leaves, and the first hinge leaf is segmented so that a first segment is perpendicular to a second adjacent segment. The first segment of the first hinge leaf is provided with at least one hole which is preferably preliminarily engaged with a mounting screw member. After the second hinge leaf is conventionally mounted to the door by screws, the first hinge leaf is positioned at the cabinet aperture with the second segment overlying the aperture edge, and the preliminarily engaged mounting screw is advanced into the cabinet to an extent sufficient to position and support the first hinge leaf, the hinge and associated components. The first hinge leaf is then conventionally mounted to the adjacent cabinet wall by screws. Preferably, when the hinge is closed, the second segment is configured to receive a portion of the second hinge leaf, thereby providing the hinge with a compact configuration.

### FIELD OF THE INVENTION

This invention relates to hinges that are adapted for associating a pivotable member, such as a cabinet door, with a stationary member, such as a cabinet, and the like which can be installed by only one person.

### BACKGROUND OF THE INVENTION

A cabinet is usually assembled and provided with at least one door-associatable opening (or aperture) before a cooperating cabinet door is connected by hinges along a side of the opening. Two or more hinges can be utilized to enable the door to pivot between open and closed positions relative to the opening. After the door is preliminarily mounted to the appropriate first hinge leaves of the selected hinges, more than one worker is usually needed to mount the respective second hinge leaves of the hinges to the adjacent side wall portion of the cabinet opening. For example, one worker may hold and position the cabinet door relative to the cabinet opening in an open door configuration that is aligned with the cabinet opening while a second worker positions and secures the individual hinge leaf mounting screws.

To reduce labor costs and improve the ease of installation, it would be desirable to avoid the need for more than one worker to install a set of hinges. This must be accomplished without sacrificing worker safety, or risking installation error, such as can occur when one worker, even though able and experienced, attempts to mount a prior art cabinet hinge that is already associated with a cabinet door.

Installation labor costs are difficult to reduce with cabinet hinges of the type where the hinge incorporates two hinge leaves which each have respective portions that nestably associate with each other when the hinge is in a closed configuration. Such cabinet hinges are evidently coming into increasing commercial usage and are perceived to be advantageous because of their small thickness when in a closed configuration. Hinges of this type require accurate location and positioning of hinge leaves and hinge leaf mounting which requirement can increase the need for more than one worker in securing a cabinet door to a cabinet.

There is thus a need for an improved hinge, particularly a cabinet hinge, which can be installed by only one person. The present invention aims to fulfill this need.

### SUMMARY OF THE INVENTION

More particularly, the present invention is directed to improved hinges that are particularly well adapted for hinging a pivotable member, such as a cabinet door, relative to a position at a stationary member, such as an aperture in a cabinet aperture, by only one person, and to methods for using the same.

Each of the hinge leaves of the inventive hinges have at least two respective segments or portions that extend perpendicularly relative to each other. When associated together by cooperating interdigitated knuckles that are associated with a pintle member, the members of a pair of hinge leaves pivot relative to each other and cooperatively engage. A first one of the two hinge leaves has one and preferably two longitudinally extending holes defined in an outer or first segment thereof, with two such holes when present preferably being longitudinally separated relative to each other.

In accordance with the invention, the second hinge leaf of a hinge is first mounted in a predetermined location at the edge of a cabinet door. Then, the first hinge leaf is positioned at a predetermined location along a cabinet aperture so that the outside or first segment of the first hinge leaf is flattened against an adjacent aperture wall portion with the adjacent or second leaf segment of the first hinge leaf extending over an adjacent aperture wall edge portion. Next, at least one of such longitudinally extending holes in the first segment has a screw means extended therethrough. Thereby, the first hinge leaf can support that hinge leaf, the hinge, and associated components. The first hinge leaf can then be mounted by screw members to the adjacent aperture wall portions. The need for more than one worker to install the hinge upon a cabinet after the hinge is mounted to a door is thus obviated.

One worker is able to install a cabinet door readily and conveniently to a cabinet using at least one embodiment of the inventive hinge by practicing the method of use provided by the invention.

In accord with a preferred embodiment of the invention, the second hinge leaf is provided with at least one and preferably two transversely elongated holes, with two such holes when present preferably being longitudinally separated relative to each other. When such holes are associated with mounting screws to the cabinet door, then, after the first hinge leaf has been supported, as indicated above, by at least one screw member that is mounted to an aperture wall through a longitudinally elongated hole in the first segment of the first hinge leaf, the position of the particular door can be adjusted while the (illustrative horizontal) position or spacing of the first hinge leaf relative to the adjacent cabinet aperture edge is maintained, and while the (illustrative vertical) position or spacing of the second hinge leaf relative to the affixed adjacent cabinet door is maintained.

The invention can be practiced with various different embodiments of the inventive hinge and with various different types of screw members, as those skilled in the art will readily appreciate. It is convenient and preferred to employ headed screws.

In addition to the indicated elongated holes, the leaves of a hinge of the invention are preferably provided with round (circular) holes adapted for receipt of mounting screw members therethrough.

As a means for expediting and simplifying installation, a hinge of the invention is preferably provided with holes that permit each hole to be preliminarily associated threadably with a portion of a mounting screw member. Thereby, the need to preliminarily locate and threadably associate a screw member with a hinge leaf during hinge installation is avoided. Preferably, the preliminarily threading involves a forward end-adjacent region of a mounting screw member so that the forward end of the screw member is in non-interfering relationship with a surface that is subsequently located adjacent to the opposite wall surface or adjacent face of the involved hinge leaf.

Conveniently and preferably, the cabinet door and the cabinet wall at the cabinet aperture are pre-drilled, as under factory made, precise, automatic, machine controlled conditions. The provision of screw-receiving holes at precise locations in a cabinet door and in a cabinet aperture wall can shorten and simplify the cabinet door hinging procedure.

Depending upon the desires of a user, the locating screw members utilized in the indicated elongated hinge leaf holes can, after usage in a mounting and positioning procedure, either be advanced and tightened against an associated hinge leaf member or removed after hinge installation by other screw members.

In an inventive hinge, optionally, the hinge leaves can incorporate the same or a different number of leaf segments. The selection of hinge leaves adapts a particular hinge for usage in a particular association with respective edge portions of, for example, a particular cabinet door or a particular cabinet wall adjacent to a door receiving aperture. Preferably, the respective segmented hinge leaf structures of a given hinge are configured so that an adjacent leaf segment of each pair of hinge leaves in an inventive hinge are cooperatively interfacially engageable with one another when the hinge is in a closed configuration.

In a presently preferred embodiment of an inventive hinge, the two hinge leaves differ from one another. A first, or cabinet mounted, hinge leaf has three segments wherein the first and the second segments are each generally flat, and extend in spaced, parallel relationship to each other while the third segment interconnects the first and the second segments along respective adjacent edge portions of the first and the second segments and extends vertically therebetween. The second, or cabinet door mounted, hinge leaf has two segments wherein the first segment perpendicularly interconnects with the second segment along a common edge portion. The third segment of the first hinge leaf adjoins the second segment of the second hinge leaf, and along the adjoining region of each of these respective segments there is defined from one to about three knuckles. The knuckles interdigitate with one another, the knuckles of the third such segment are pivotable relative to the knuckles of the second such segment, and the knuckles are interconnected together along their pivot axis by a common pintle.

Preferably, in an inventive hinge, the respective configurations and relationship between the first and the second hinge leaves are such that, when the hinge is in a closed configuration, the second segment of the first hinge leaf is provided with an opening that is adapted to receive a portion of either the first or the second segment of the second hinge leaf when the respective knuckle adjacent segments of each hinge leaf are otherwise in face-to-face relationship with each other.

Other and further objects, aims, purposes, features, advantages, embodiments, equivalent alternatives, and the like will be apparent to those skilled in the art from the teachings of the present specification taken with the accompanying drawings and the appended claims.

### BRIEF DESCRIPTION OF THE DRAWINGS

In the drawings:

FIG. 1 is an environmental perspective view of one embodiment of the inventive cabinet hinge showing the cabinet hinge in an open configuration, the hinge being in combination with illustrative mounting screws, and also with a cabinet (fragmentarily shown in phantom) and a cabinet door (fragmentarily shown in phantom);

FIG. 2 is an environmental perspective view similar to FIG. 1 showing the FIG. 1 hinge but taken from a complementary angle; G11

FIG. 3 is an elevational view of the right side of the FIG. 1 hinge, the hinge being in combination with illustrative mounting screws;

FIG. 4 is an elevational view of the left side of the FIG. 1 hinge, the hinge being in combination with illustrative mounting screws;

FIG. 5 is an view similar to FIG. 2, but showing the hinge embodiment in an exploded condition;

FIG. 6 is an elevational view of the front side of the FIG. 1 hinge, including the illustrative mounting screws and the illustrative cabinet and cabinet door, as shown in phantom;

FIG. 7 is a top view of the FIG. 1 hinge with the illustrative mounting screws and with the illustrative cabinet and cabinet door, as shown in phantom;

FIG. 8 is a top view similar to FIG. 7, but showing the hinge embodiment in a closed position with the illustrative mounting screws and with the illustrative cabinet and cabinet door, as shown in phantom;

FIG. 9 is an environmental perspective view of another embodiment the inventive hinge, the hinge being in combination with illustrative mounting screws, and also with a cabinet (fragmentarily shown in phantom) and a cabinet door (fragmentarily shown in phantom);

FIG. 10 is an environmental perspective view similar to FIG. 9 showing the FIG. 9 hinge but taken from a complementary angle

FIG. 11 is an environmental perspective of another embodiment of the inventive hinge, the hinge being in combination with illustrative mounting screws, and also with a cabinet (fragmentarily shown in phantom) and a cabinet door (fragmentarily shown in phantom);

FIG. 12 is an elevational view of the right side of the hinge embodiment shown in FIG. 11;

FIG. 13 is an elevational view of the left side of the hinge embodiment shown in FIG. 11;

FIG. 14 is an environmental perspective of another embodiment of the inventive hinge;

FIG. 15 is a top view of the FIG. 14 hinge in association with illustrative mounting screws and with an illustrative cabinet and cabinet door shown in phantom;

FIG. 16 is a top view similar to FIG. 15, but showing the hinge embodiment in a closed position with the illustrative mounting screws and with the illustrative cabinet and cabinet door shown in phantom;

FIG. 17 is a perspective view of a further alternative embodiment of the inventive hinge;

FIG. 17A is a rear elevational view of the hinge shown in FIG. 17;

FIG. 18 is a top plan view of the hinge embodiment shown in FIG. 17 in illustrative association with a cabinet (shown in section) and a cabinet door (shown in section) and with illustrative mounting screws (shown in phantom), the hinge being shown in a closed position;

FIG. 19 is a view similar to FIG. 18, but showing the hinge with the leaves open 90° relative to their position shown in FIG. 18;

FIG. 20 is a view similar to FIG. 18, but showing the hinge with the leaves open 180° relative to their position shown in FIG. 18;

FIG. 21 is a view similar to FIG. 18, but showing the hinge with the leaves open 270° relative to their position shown in FIG. 18;

FIG. 22 is an environmental perspective view of another embodiment of the inventive hinge showing the hinge in an open configuration, the hinge being in combination with illustrative mounting screws, and also with a cabinet (fragmentarily shown in phantom) and a cabinet door (fragmentarily shown in phantom);

FIG. 23 is an elevational view of the right side of the FIG. 22 hinge;

FIG. 24 is an elevational view of the left side of the FIG. 22 hinge;

FIG. 25 is a top plan view of the FIG. 22 hinge, the hinge being in combination with the illustrative mounting screws, and also with the illustrative cabinet and cabinet door (fragmentarily shown in phantom);

FIG. 26 is a front elevational view of the FIG. 22 hinge;

FIG. 27 is a rear elevational view of the FIG. 22 hinge;

FIG. 28 is an elevational view similar to FIG. 22 but showing the hinge in a closed position;

FIG. 29 is an elevational view of the right side of the FIG. 28 hinge;

FIG. 30 is an elevational view of the left side of the FIG. 28 hinge;

FIG. 31 is a top plan view of the FIG. 28 hinge, the hinge being in combination with the illustrative mounting screws, and also with the illustrative cabinet and cabinet door (fragmentarily shown in phantom);

FIG. 32 is a front elevational view of the FIG. 28 hinge; and

FIG. 33 is a rear elevational view of the FIG. 28 hinge;

### DETAILED DESCRIPTION

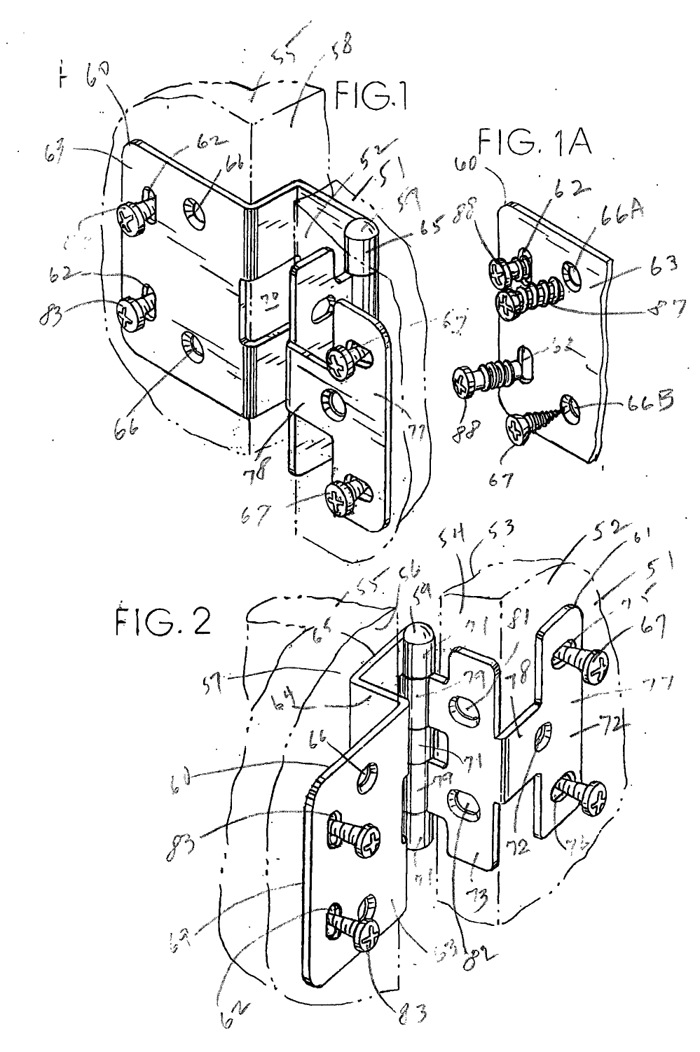

Referring to FIGS. 1-8, there is seen an embodiment 50 of a hinge of the invention. Hinge 50 is particularly well adapted for use in hanging (or hinging) a cabinet door relative to a cabinet for opening and closing swinging movements of the door relative to an aperture defined in one side of the cabinet that cooperatively associates with the door. Here, an illustrative cabinet door 51 (fragmentarily shown in phantom) has respective inside and outside faces 52 and 53, a back side edge 54, and also a front side edge, a top side edge, and a bottom side edge (not detailed). An illustrative cabinet 55 (fragmentarily shown in phantom) has an aperture 56 that includes a side piece 57 located along the edge region thereof. More than one hinge 50 may be employed, if desired (not detailed), to hinge the door 51 relative to the cabinet 55. Hinge 50 can be conventionally fabricated of metal (preferred) or plastic. The cabinet 55 and the cabinet door 51 are conventional and can be comprised of conventional materials. For example, cabinet 55 and cabinet door 51 may have cores comprised of fiberboard or particle board that are adapted to receive and hold wood-type screws that may be advanced (screwed) thereinto for purposes of mounting and supporting hinges, such as hinges 50.

The hinge 50 includes a hinge pintle 59, a first hinge leaf 60 with knuckles 71, and a second hinge leaf 61 with knuckles 79. The first hinge leaf 60 includes three integral segments, identified as flattened first segment 63, flattened second segment 64, and flattened third segment 65. The first segment 63 has a plurality (here illustratively two) of conventional circular holes 66 defined therein for receiving therethrough fasteners, such as headed screws 67 or the like, that mount the first segment 63 and the first hinge leaf 60 to the side piece 57 adjacent to an edge region 58 of the aperture 56 of the cabinet 55. The holes 66 can be variously arranged, though two holes 66 are presently preferred which are in longitudinally spaced and aligned relationship relative to each other.

First segment 63 also has at least one (here illustratively and preferably two) longitudinally (relative to the length of the first segment 73) elongated holes 62 that are adapted for receipt therethrough of mounting means, such as headed screws 67 or the like. The leaf segments 63, 64 and 65 each may be considered to have preferably a generally rectangular perimeter configuration.

Considering the pintle 59 for present descriptive purposes to be the central region of hinge 50, the rear side of the second leaf segment 64 of the first hinge leaf 60 joins the forward side of the first leaf segment 63. The second leaf segment 64 extends perpendicularly relative to the first leaf segment 63. The length and width of the second segment 64 are such as to permit the segment 64 to overlie an edge region of the aperture 56 in cabinet 55. The second segment 64 has defined in a medial location thereof an relatively large opening 70 that extends across the width of the second segment 64 and that preferably has, as shown (see, for example, FIG. 4) a rectangular configuration.

The rear side of the third leaf segment 65 of the first hinge leaf 60 joins the forward side of the second leaf segment 64 and extends perpendicularly outward relative to the second leaf segment 64 and parallel relative to the first leaf segment 61.

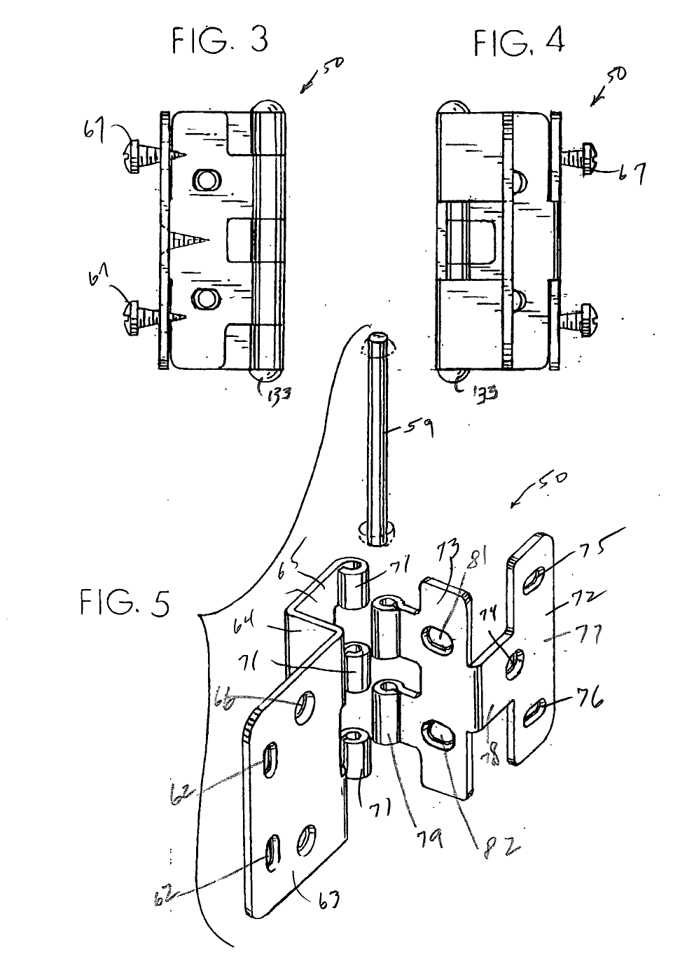

Along the forward side of the third leaf segment 65, a plurality of longitudinally spaced knuckles 71 (here illustratively and preferably three as seen, for example, in FIG. 2 or 5) are located that extend generally parallel to a (hypothetical) plane defined by the third segment 65 and also generally parallel to the second segment 64. As illustrated in FIGS. 3 and 4, the lowermost knuckle 71 is provided with a pintle cap 133 (not detailed) for aesthetic purposes.

The second hinge leaf 61 includes two integral segments, a flattened first portion (or segment) 72, and a flattened second portion (or segment) 73. The first leaf portion 72 has a plurality (here illustratively three as seen, for example, in FIGS. 2 or 5) of holes such as, for illustration, holes 74, 75 and 76, that are defined therein for receiving therethrough fasteners, such as headed screws 67, or the like, that mount the second hinge leaf 62 to the inside face 52 of the cabinet door 51 adjacent to the back side edge 54 thereof. Here, the hole 74 is medially positioned in the first portion 72 and has a round configuration. The holes 75 and 76 are generally adjacent to the rear or outside edge region of the first leaf portion 72. The holes 75 and 76 are each transversely elongated (relative to the width of the first portion 72) and are preferably in longitudinally (relative to the length of the first portion 72) aligned relationship relative to each other. Preferably two such transversely elongated holes, such as holes 75 and 76, are employed in segment or portion 72 of second hinge leaf 72 of hinge 50 as shown (see, for example, FIG. 5).

The first leaf portion 72 of second leaf 61 can be considered to be comprised of two transversely adjacent, edge interconnected first and second regions 77 and 78, respectively. The second region 78 is medially located adjacent to the second portion 73 and has a reduced length relative to the first region 77, the first region 77 preferably having the holes 75 and 76 therein. The dimensions and location of the narrow portion 78 are such as to permit the portion to be received in the opening 70 defined in the second segment 64 of the first hinge leaf 60, when the hinge 50 is in a closed configuration, as further explained below. Except for region 78 in portion 72, each segment (or portion) 72 and 73 may be considered to have preferably a generally rectangular perimeter configuration.

The rear side of the second leaf portion or segment 73 of the second hinge leaf 61 joins the forward side of the first leaf segment 72 and the second leaf segment 73 extends perpendicularly relative to the first leaf segment 72. The length and width of the second segment 73 are such as to permit the leaf segment 73 to overlie a portion of the back side edge 54 of the cabinet door 51. The second leaf segment 73 is optionally but preferably also provided with holes for extending fastening (mounting) members therethrough, such as screws 67, or the like, thereby to mount the second leaf 61 to the back side edge 54 of the door 51.

Various hole arrangements can be provided in the leaves 60, 61 for hinge mounting purposes. An optional but presently preferred arrangement is to provide the second leaf segment 73 with holes 81 and 82 that are each medially located (relative to the width of second segment 73), that are each transversely elongated (relative to hinge 50), and that are preferably in longitudinally aligned, symmetrical relationship relative to the length of second segment 73 and relative to each other. The holes 81 and 82 are adapted for receiving therethrough fasteners, such as headed screws 67 or the like, that mount the second leaf segment 73 and hinge leaf 62 to the back side edge 54 of the cabinet door 51 adjacent to the inside face 52 thereof.

The feature that elongated holes, such as holes 81 and 82, in second segment 73, and elongated holes 75 and 76 in the first segment 72, permit, if desired, the hinge 50 to be adjustably positioned relative to the cabinet door 51 and to mounting members, such as screws 67 or 87, after the screws have been mounted to the cabinet 55 and the door 51, as those skilled in the art will appreciate.

Along the forward side of the second leaf segment 73, a plurality of slightly forwardly projecting spaced knuckles 79 (here illustratively two) are provided, as seen, for example, in FIGS. 2 and 5, that extend generally parallel to a (hypothetical) plane defined by the second segment 73 and also generally parallel to the first segment 72.

In the assembled hinge 50, the knuckles 79 of second leaf segment 73 of the second hinge leaf 61 interdigitate with the knuckles 71 of the third segment 65 of the first hinge leaf 60. The pintle 59 is conventional and can be variously constructed and associated with the knuckles 71, 79 of a hinge 50. Here, the pintle 59 extends longitudinally through the aligned, interdigitated knuckles 71 and 79 whereby the leaves 60 and 61 are pivotable relative to each other and relative to the axis of the pintle 59. The lowermost knuckle 71 may, as shown, be provided with an optional pintle cap 133 (see FIGS. 3 and 4) for esthetic purposes, if desired. If desired, the pintle 59 can be permanently associated with the knuckles 71 and 79 by conventional manufacturing procedures, such as knurling, swedging, or the like, as those skilled in the art will readily appreciate.

In the hinge 50, the interrelationship between the first hinge leaf 60 and the second hinge leaf 61 is such that, when the hinge 50 is in a closed configuration, the second segment 73 of the second hinge leaf 61 is adjacent to the third segment 65 of the first hinge leaf 60, and the narrow portion of the first segment 72 of the second leaf 61 is nestably received within the opening 70 in the second segment of the first leaf 60. When the first hinge leaf 60 is mounted to the cabinet 55 adjacent to a portion of the aperture 56, and the second hinge leaf 61 is mounted to the cabinet door 51 along a portion of the inside face 52 of the cabinet door 51 and adjacent to a portion of the back side edge 54 of the cabinet door 51, the edge adjacent portions of the inside face 52 of the cabinet door 51 overlie outside edge adjacent portions of the aperture 56 of the cabinet 55 when the hinge 50 is in a closed configuration, as illustrated, for example, in FIG. 8.

In place of screws 67, other types of mounting members can be used, if desired, as those skilled in the art will appreciate, such as nails, sheet metal screws or rivets (as in the case of a cabinet or cabinet door constructed of sheet metal), or the like. As is typical of hinges of the invention, the hinge 50 can be used with various mounting screws, as those skilled in the art will readily appreciate.

For example, in place of tapered wood-type screws 67 (or 83), as illustrated in FIG. 1A, holes 62 and 66 can be threadably and preliminarily associated with modified machine screws, such as, for example, the screws 88 and 87, respectively, by an installer of a hinge 50, or by a manufacturer or supplier of hinge 50 who conveniently and preferably employs appropriate automatic machinery, or otherwise. Screws, such as screws 87 and 88, are characterized by having a shank portion that is of generally uniform diameter and that is threaded. Thus, preferably preliminarily, the threaded portion adjacent to the forward end region of the shank of a screw 88 is threadably associated with, for example, a hole 62, preferably in a mid-longitudinal portion thereof, that is in segment 63 of the leaf 60. The threaded region adjacent to the forward end portion of the shank of a screw 87 is threadably associated with, for example, a hole 66A (see FIG. 1A) in the first segment 63 of first hinge leaf 60. For illustration purposes, the hole 66A in FIG. 1A is provided with a tapered entry face, thereby to permit, if desired, the hole 66B to receive in a counter-sunk manner a head portion of a wood type screw 67 having a tapered shank that is extended through the hole 66B.

When, for example, the first segment 63 of first hinge leaf 60 is being mounted to a cabinet, such as cabinet 55, as is achieved in the practice of the method of the invention, as further described below, a screw 88 that has preferably been initially threadably associated with a hole 62, after a suitable predrilled hole 86 in side piece 57 of aperture 56 of cabinet 55 is aligned therewith, as described below, is conveniently advanced into cabinet 55 by a powered screw driver or the like (see, for example, FIGS. 29 and 30), thereby to locate preliminarily, and to support and position, the first hinge leaf 60, relative to the cabinet 55. Thereafter, each screw 87 that has preferably been initially threadably associated with a hole 66 is threadably advanced into engagement with a preferably aligned, predrilled hole 86 in the cabinet 55 until the head of each screw 87 engages adjacent surface portions of the first hinge leaf 60. Preferably, after the screws 87 have so mounted the first hinge leaf 60, the screw 88 can either be advanced through the first hinge leaf 60 until the head thereof engages adjacent surface portions of the first hinge leaf 60, or be retracted (separated) from the first hinge leaf 60, as desired. When so advanced, the screw 88 aids in mounting the hinge 50 to a cabinet 55.

Conveniently and preferably, the threaded shank portion of a screw 87 that has been preliminarily threadably engaged at its forward end region with a hole 66 and that has been advanced through the hole 66 and into threaded engagement with a preformed hole 86 in a cabinet 55 or the like, so that the screw 87 head is contacting the leaf adjacent to the hole 66, remains threadably engaged with the hole 66, thereby helping to support and mount the hinge 50. Alternatively, if desired, a screw 88 can be preliminarily associated with a hole 66. Then, when the screw 88 is fully advanced through the hole 66, the screw 88 is not threadably engaged with the hole 66 because the screw 88 threads are discontinuous adjacent the screw 88 head (as shown in FIG. 1a) so that, when the shank of a screw 88 is fully extended into a cabinet 55, the fully engaged screw 88 is not threadably associated with the hole 66.

When the shank of a screw 88 that has been preliminarily threadably engaged at its forward end region with a hole 62 is advanced fully in the hole 62 and into the cabinet 55, so that its head engages adjacent portions of the first segment 63, the upper end portion of the shank of the screw 88 becomes threadably disengaged from the adjacent hole 62. This result occurs because, as illustrated in FIG. 1A, the threads on the screw 88 are discontinuous adjacent the head thereof. In such disengaged condition, the elongated hole 62, and hence also the first segment 63 and first leaf 60, are slidably movable relative to the mounted screw 88 and hence also the cabinet 55, such as may be desired for leaf 60 position adjustment purposes relative to cabinet 55 during the mounting of a hinge 50 relative to a cabinet 55 or the like. Thus, a slight loosening of a previously tightened screw 88 in a hole 62 permits the hinge 50 to be moved relative to the screw 88 as may be desired for hinge 50 adjustment purposes relative to a cabinet 55 or the like.

In a presently preferred practice of the invention, the mounting holes in a hinge 50 are preliminarily threadably associated with the forward end regions of screws whose shanks have threads which are not tapered like wood screws, such as screws 87 and 88. Not only does such an association aid in reducing the labor and time associated with the installation of a hinge 50, but also such a preliminary association of screws with mounting holes facilitates and enhances the practice of the hinge installation method achieved by this invention, as described herein.

The hinge 50 may be employed in practicing the method of hinge installation provided by the present invention. Thus, when the cabinet door 51 is to be hung relative to a cooperatable aperture 56 in the cabinet 55, the following steps are preferably taken: Initially, the approximate reciprocal or corresponding locations on each of the door 51 and the cabinet 55 where a hinge 50 is to be associated are selected.

Next, the second hinge leaf 61 can be mounted to the cabinet door 51 at the selected inside face 51 location and adjacent back side edge 54 location conveniently using the holes 74, 75 and 76 in segment 72 and preferably but optionally the holes 81 and 82 in segment 73 in combination with a fastening members, such as a headed screws 67, or 87, or the like, in association with each such leaf hole utilized.

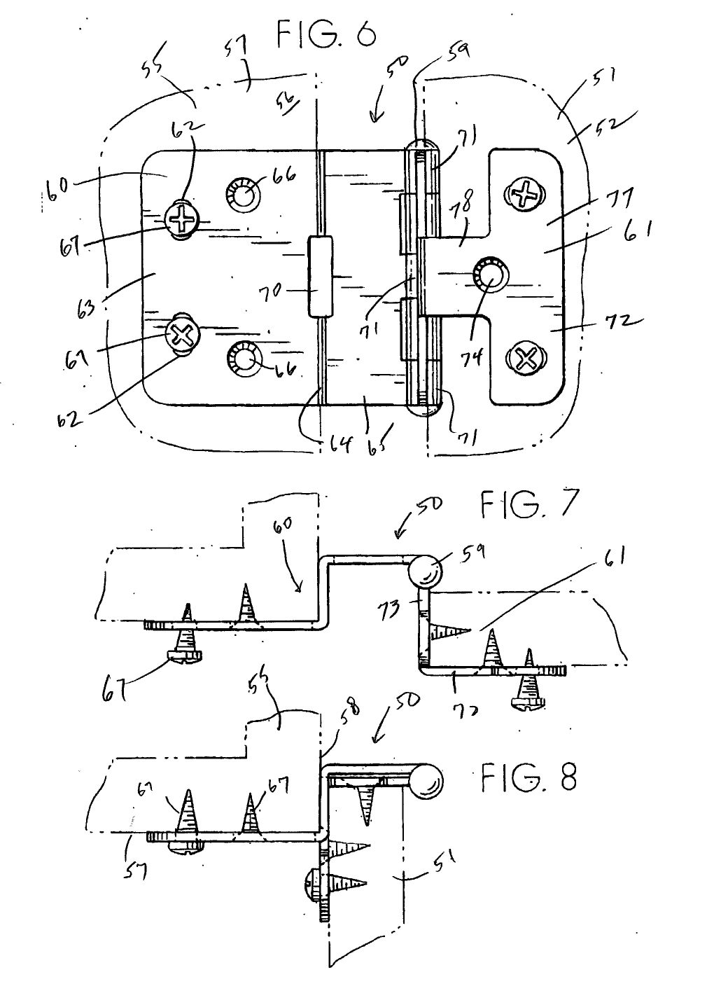

Next, with the hinge 50 so associated with the door 51, the first hinge leaf 60 is positioned at the selected location at the aperture 56 adjacent the side piece 57 in the cabinet 55 with the second segment 64 of leaf 60 located adjacent to a portion of the edge region 58 and the first segment 63 adjacently located upon the side piece 57 of aperture 56. A locating and supporting screw, such as a screw 67 or 87 or the like, is selected and mounted in the wall portion of the cabinet 55 through an elongated hole 62 in first segment 63 of leaf 60. More than one elongated hole 62 can be associated with such a screw. If two holes 62 are present in segment 63, then a selected screw member 67 can be mounted through each hole 62 (see, for example, FIGS. 2 and 7). In general, the screw selected needs to have the capacity as mounted to the cabinet 55 to hold and support a first hinge leaf 60 when and while the second hinge leaf 61 is fully associated with the cabinet door 51. Since the holes 62 are elongated, the position of a leaf 60 is longitudinally adjustable relative to a screw that is mounted through a hole 62 until the screw is tightened against the leaf 60.

Next, the first leaf 60, as duly located positioned and supported by at least one screw 67 or 87 or the like each mounted to the cabinet 55 through at least one hole 62, is mounted to the cabinet 55 in the selected position preferably using a plurality of screw type fasteners, such as screws 67, 87, or the like, that each extend through a different hole 66 in segment 63.

Thereafter, optionally, after the leaf 60 is duly mounted to the cabinet 50 in the selected position, the screw(s) 67 or 87 or the like in the hole(s) 62 can be advanced until the heads of such screws are engaged with the segment 63. Alternatively, if desired, the screw(s) 67 or the like can be removed from the hole(s) 62 after fasteners such as screws 67 have been engaged with the holes 66 and the leaf 60 has been thereby mounted to the cabinet 55. Thus, by the present method, only one person is needed to mount a hinge 50 that is already mounted to a cabinet door 51 to a cabinet 55.

For hinge installing convenience, accuracy and saving of time in practicing the installing method, self-threading screw receiving holes, such as holes 86, or the like, may be, and preferably are, positioned and predrilled in the cabinet 55 and/or in the cabinet door 51 at the predetermined locations in which a hinge leaf, such as those of a hinge 50 of the invention, is to be installed. For example, a cabinet or cabinet door manufacturer can use, for example, precision jigs, automatically operating equipment, computer controls, and/or the like, as those skilled in the art will appreciate. Subsequent installation of a hinge or hinges of the invention can be carried out a fabrication site, at a cabinet installation site, or elsewhere, as desired. For example, a cabinet installation site may be desirable as a location for the practice of the inventive hinge installation procedure, as when, for example, a cabinet door customer has selected a particular type or style of cabinet door from among a plurality of cabinet doors for use with a given cabinet.

Also for installing convenience, accuracy and saving of time in practicing the present installation method, screws such as screws 67, 87, or the like, are preferably preliminarily threadably associated with holes 62 and 66. Thereby, the time and need to preliminarily locate and threadably associate a screw member with a hinge leaf during hinge installation is avoided. Preferably, the preliminarily threading involves a forward end-adjacent region of a mounting screw member so that the forward end of the screw member is in non-interfering relationship with a leaf surface that is subsequently located adjacent to a cabinet wall or a cabinet door, for example.

A hinge of the invention can be employed in combination with various types of mounting means to practice the inventive hinge installation method. However, screws are presently preferred, such as the screws 67 and 87, above illustrated and described. A present preference for achieving the practice of the method of this invention is to utilize prepositioned and predrilled holes in a cabinet and in a cabinet door for installation of a hinge of the invention.

Those skilled in the art will appreciate that variations in the order and arrangement of hinge installation method steps can be employed, and that variations in particular method steps can be utilized without departing from the spirit and intent of the present inventive method of assembly of cabinet door to cabinet using a hinge of the invention. For example, when predrilled screw receiving holes are provided before hinge 50 installation, the leaf 61 can be mounted to a cabinet door with screws, such as screws 67, or screws 87, before the screw 83 is mounted in the cabinet 55. Although preferentially in the practice of the hinge installation method a cabinet door is preliminarily mounted to a hinge of the invention before the hinge is mounted to a cabinet, this order of procedure may be reversed if desired or needed, as those skilled in the art will readily appreciate, without departing from the spirit and scope of the invention.

Also, those skilled in the art will readily appreciate that the inventive method can be practiced with various embodiments of hinges of the invention and with various means for fastening a hinge of the invention to surface portions of a cabinet or a cabinet door. The hinge installation method of the invention permits an embodiment of the inventive hinge to be installed by only one worker.

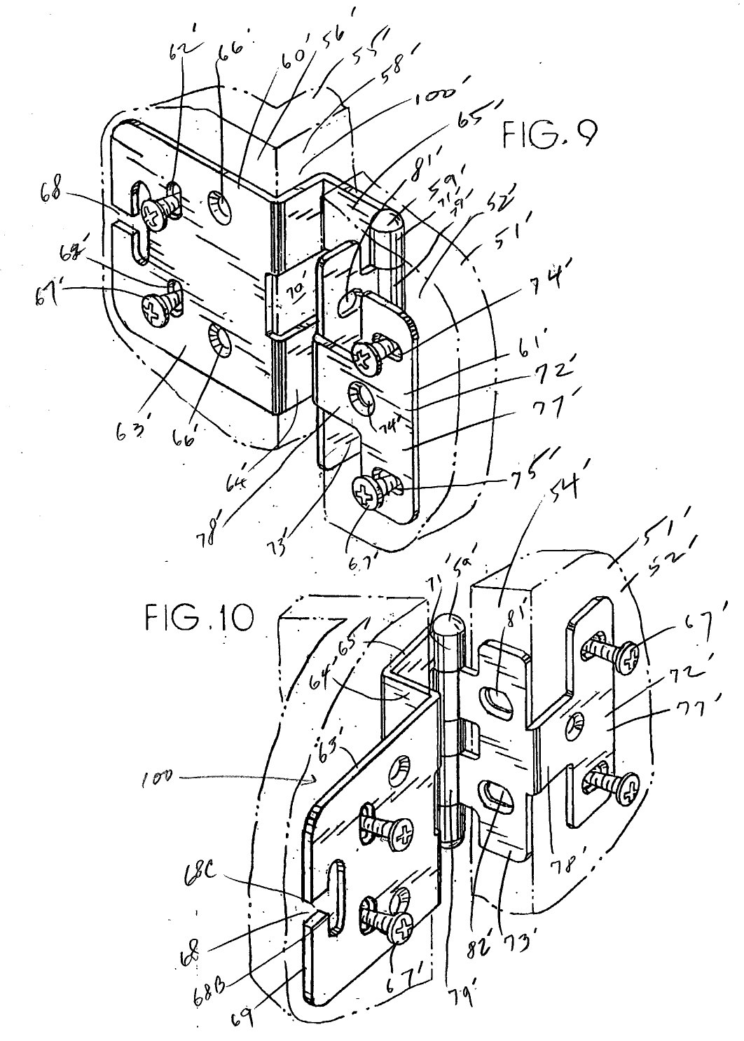

Referring to FIGS. 9 and 10, there is seen a second embodiment 100 of a hinge of the invention. Portions of the hinge 100 can be considered to correspond to portions of the hinge 50. For convenience and brevity, portions of hinge 100 that correspond to portions of hinge 50 are similarly numbered but with the addition of prime marks for identification purposes.

The hinge 100 has a somewhat transversely (relative to first segment 63) elongated and relatively narrow channel 68 defined therein that includes (see, for example, FIG. 10) an opening 68C which opens outwardly at a medial rear side edge portion 69 of first segment 63. Channel 68 includes an inwardly extending channel portion 68A that extends a relatively short distance and that connects with and terminates at a mid-region of a cross-wards and longitudinally extending portion 68B. To provide enhanced access to, and a connecting base for, the channel 68, the first segment 63 here includes in its rear side edge portion 69 an integral outwardly extending projection or extension in which the channel 68 is defined. The features and functioning of the channel 68 are considered in the copending patent application filed on even date herewith and identified by Docket No. SI-03 and the teachings therein are incorporated here by reference. The incorporation of one or more channels 68 or the like in a hinge such as hinge 100 is believed to enhance hinge versatility and suitability for various purposes and applications. The presence of a channel 65 or the like in a hinge of the invention such as hinge 100 makes possible an alternative procedure for hinge mounting relative to a cabinet or the like, if desired.

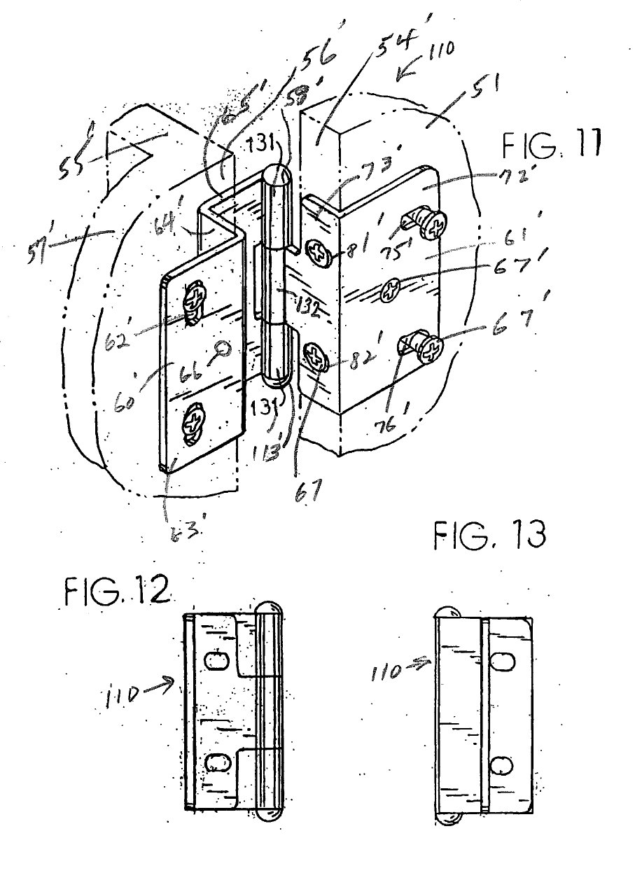

Referring to FIGS. 11-13, there is seen a third embodiment 110 of the inventive hinge. The hinge 110 has components and portions which are similar to components and portions of the hinge 50, and corresponding components and portions in hinge 110 which are similar to those in hinge 50 are similarly numbered but with the addition of prime marks for identification purposes.

Principal differences between the hinge 110 and the hinge 50 include: (a) The hinge 110 includes a segment 64′ in first leaf 60′ that does not include any opening (such as opening 70 in segment 64 in hinge 50) and segment 73′ in second leaf 61′ extends continuously (and does not include forward and rearward regions 77 and 78 as in segment 73 of second leaf 61 in hinge 50). When the hinge 110 is in its closed configuration, the second segment 73′ is located adjacent to the third segment 65′ of the first leaf 60′ and the second segment 64′ of the first leaf 60′ is located adjacent to a portion of the first segment 72′ of the second leaf 61′. (b) The hinge 110 includes three knuckles (instead of five knuckles as in the hinge 50). In hinge 110, two longitudinally spaced knuckles 131 extend outwardly from the forward side of the third segment 65′ of leaf 60′ and are oriented generally parallel to the second segment 64′ while one knuckle 132 extends outwardly from the forward side of the second segment 73′ of leaf 61′ and is oriented generally parallel to the first segment 72′ of leaf 61′. The knuckle 132 is interdigitated between the two knuckles 131. The pintle 59′ extends longitudinally through the aligned, interdigitated knuckles 131 and 132 whereby the leaves 60′ and 61′ are pivotable relative to each other and to the axis of the pintle 59. As in the hinge 50, the lowermost knuckle 131 is optionally provided with a pintle cap 113′ (not detailed) for esthetic purposes.

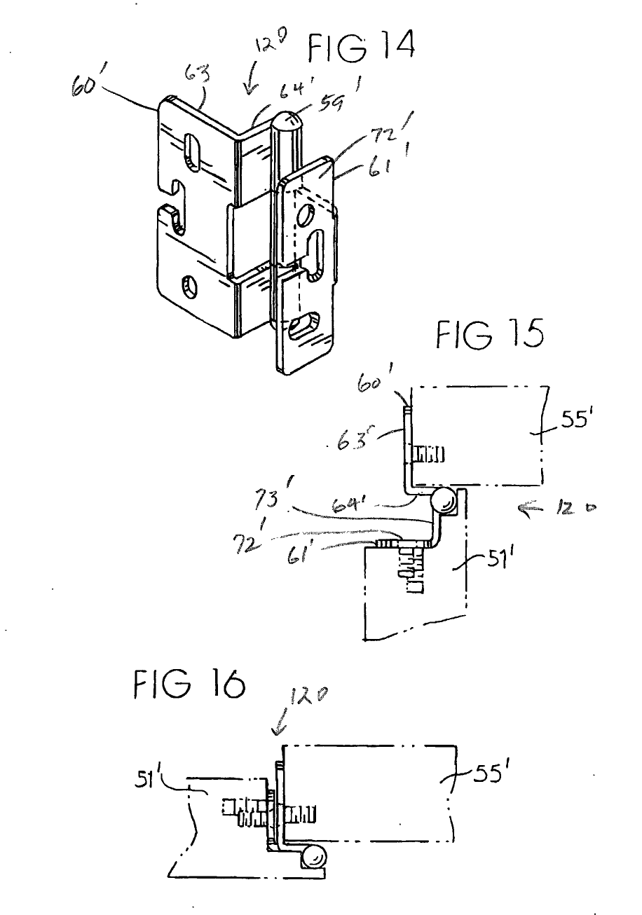

Shown in FIGS. 14-16 is a fourth embodiment 120 of the inventive hinge. Hinge 120 is similar to hinge 50 and corresponding parts are similarly numbered but with the addition of prime marks for addition purposes.

Principal distinctions between hinge 120 and hinge 50 include: (a) The hinge 120 has a first hinge leaf 60′ that incorporates only two (and not three, as in hinge 50) segments that are identified, respectively, as first segment 63′ and second segment 64′ while the second leaf 61′ of the hinge 120 incorporates first and second segments 72′ and 73′, respectively. (b) The segment 73′ of the second hinge leaf 61′ is narrow and is received in the opening 70′ defined in the segment 64′ of the first hinge leaf 60′ when the hinge 120 is in a fully closed configuration. (c) The first segment 63′ is provided with one longitudinally elongated hole 62′ and one round hole 66′ that is as shown preferably longitudinally downwardly spaced from the hole 62′ while the first segment 72′ of the second leaf 61′ is provided with one transversely elongated hole 75′ and one round hole 74′ that is as shown preferably longitudinally upwardly spaced from the hole 75′. The holes 62′ and 75′ each function similarly to the holes 62 and 75 provided in the hinge 50, above described. (d) Optionally, and as shown, each of the first leaf 60′ and the second leaf 61′ is provided with an elongated channel 68′ which has features and functions as considered in the above cited copending application filed on even date and identified by Docket No. SI-03 whose teachings are incorporated herein by reference.

FIGS. 17-21 show a fifth embodiment 130 of a hinge of the invention. Hinge 130 is similar to hinge 50 and corresponding parts are similarly numbered but with the addition of prime marks.

Principal distinctions between hinge 130 and hinge 50 include: (a) The hinge 130 has a first hinge leaf 60′ that incorporates only two (and not three, as in hinge 50) segments that are identified, respectively, as first segment 63′ and second segment 64′. (b) The hinge 130 has a second hinge leaf 61′ that incorporates only one segment (and not two, as in hinge 50). (c) No portion of the second hinge leaf 61′ is nestably received within any portion of the first leaf hinge 60′ when the hinge 130 is in a fully closed configuration in contrast to hinge 50. (d) In the hinge 130, the second hinge leaf 61′ is received against the face of the second segment 64′ of the first hinge leaf 60′ when the hinge 130 in a fully closed configuration. (e) The hinge 130 includes one optional longitudinally elongated channel 131 in the first segment 63′ of leaf 60′ and two longitudinally elongated holes 62′. The channel 131 has features and functions as considered in in the channel 68 provided in the above cited copending application filed on even date and identified by Docket No. SI-03 whose teachings are incorporated herein by reference.

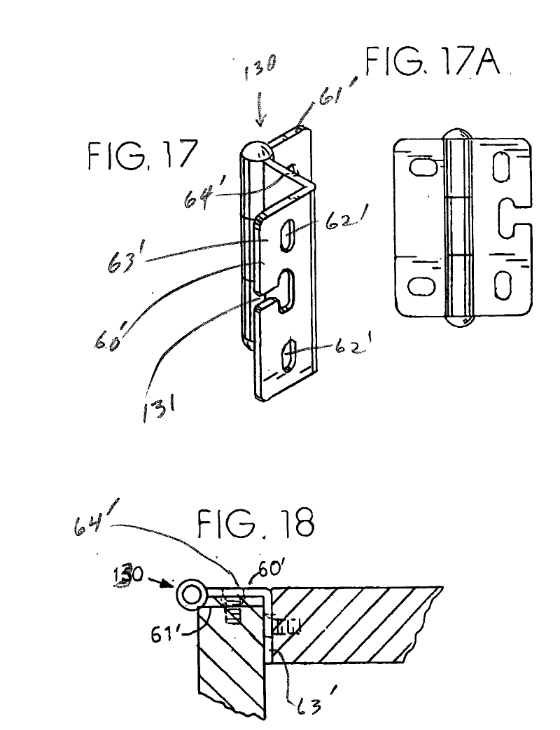

The hinge 130 enjoys applications that may be distinguished from those for hinge 50, for example. Thus, the hinge 130, as illustrated in FIGS. 18-21, permits a cabinet door 51′ to pivot through 270° relative to a cabinet aperture 56′ from a door closed position (see FIG. 18) progressively to a door fully open position (see FIG. 21).

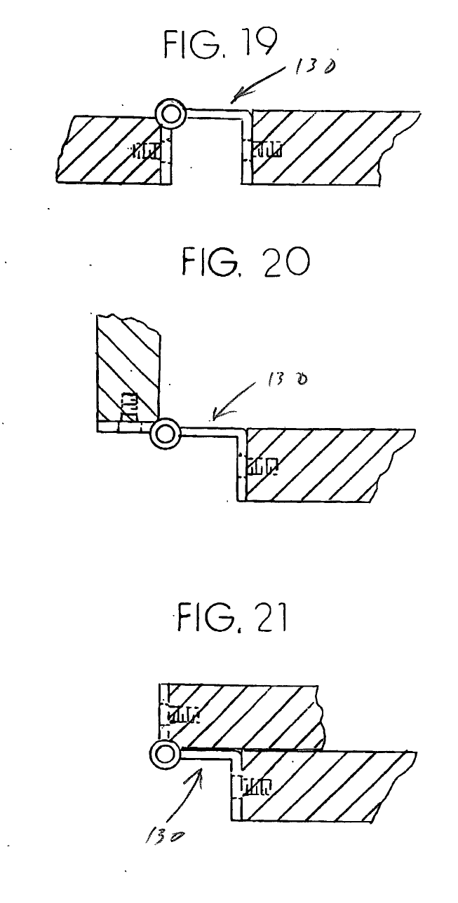

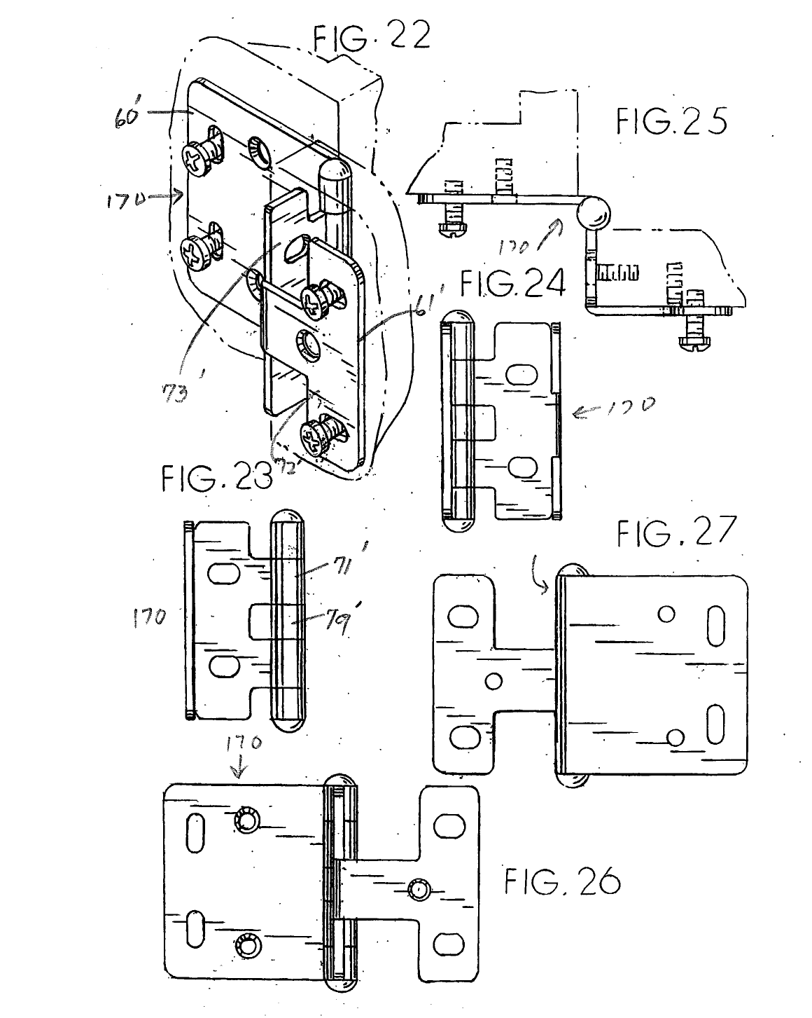

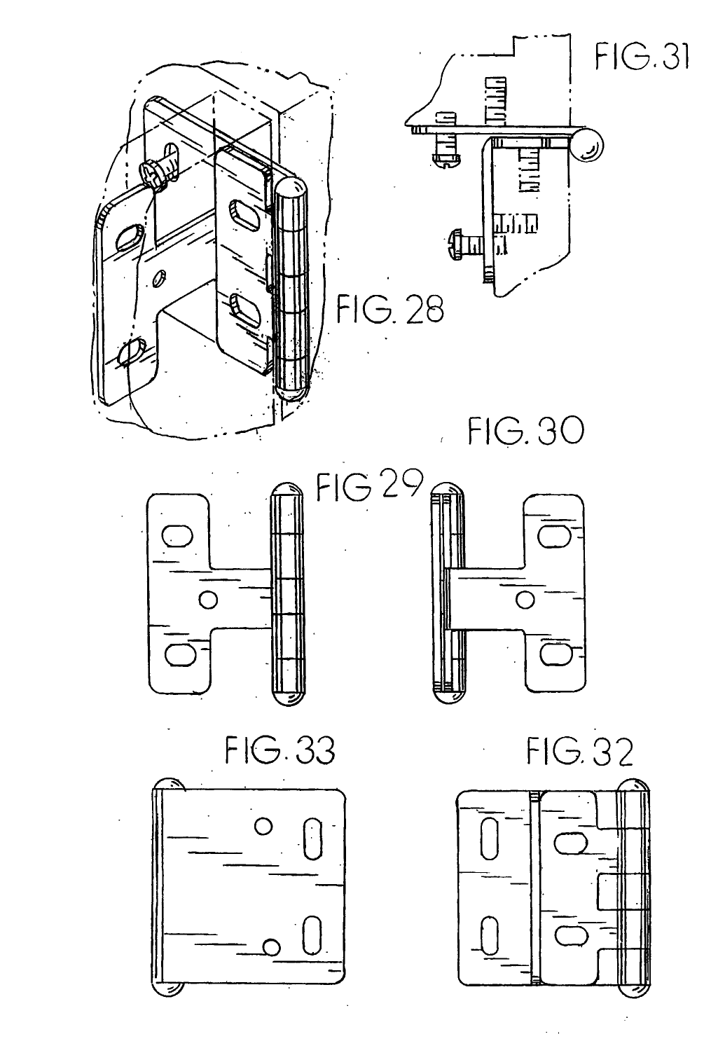

FIGS. 22-32 show a sixth embodiment 170 of a hinge of the invention. Hinge 140 is similar to hinge 50 and corresponding parts are similarly numbered but with the addition of prime marks.

Principal distinctions between hinge 170 and hinge 50 involve the circumstance that in hinge 170 hinge leaf 60′ is flat while hinge leaf 61′ is L-configured and comprises two segments 72′ and 73′ that are edge connected and perpendicular to one another. Leaf 61′ has a structure that is similar to leaf 60 in hinge 50. No portion of hinge leaf 61′ is nestably received in any portion of hinge leaf 60′. The width of the segment 73′ is chosen to accomodate the edge portion of a selected cabinet door 51′. The segment 73′ joins the segment 72′ in a forward narrowed region 77′ of the segment 72′., and the longitudinal width of the segment 73′ corresponds to the longitudinal width of the region 77′ of the segment 72′. The forward region 77′ joins medially the segment 72′, and the longitudinal length of the rearward region 78′ of the segment 72′ is substantially greater than that of the forward region 77′, as in the segment 72 of the hinge 50. The leaf 60′ is provided with an elongated holes 62′ as in the hinge 50. The holes are preferably preliminarily associated with screws such as 87 or 88. The hinge 170 is adapted for use as a so-called inset hinge where a cabinet door 51′ may be inset relative to the aperture 56′ of a cabinet 55 in contrast to the hinge 50 that is adapted for use as a so-called overlay hinge where a cabinet door 50 may overlap edge portions, if desired, of a cabinet 55 aperture 56.

Various other embodiments, applications, features, alternative but equivalent structures, and the like will be apparent to those skilled in the art from the present description of the invention and no undue limitations are to be drawn therefrom.

What is claimed is:

1. A hinge adapted for use in hinging a cabinet door relative to an aperture in a cabinet for swinging movements of said door between open and closed hinge positions relative to said aperture, said door having respective inside and outside faces and a back side edge, said cabinet including a side piece means located along said aperture and adjacent said back side edge, said hinge comprising:
a hinge pintle and first and second hinge leaves;
said first hinge leaf comprising progressive, interconnected first and second respective flattened segments,
said first segment having defined therein
at least one round hole for receipt therethrough of mounting means, and
at least two longitudinally separated holes that are each longitudinally elongated and adapted for receipt therethrough of mounting means,
said second segment extending perpendicularly relative to said first segment, said second segment
being adapted to overlie an edge portion of said aperture, and
including first knuckle means located along an outer edge region of said second segment for receiving said pintle;
said second hinge leaf comprising a flattened portion,
said second hinge leaf having at least one round hole defined therethrough for receipt therethrough of mounting means,
said second hinge leaf including second knuckle means located along an outer edge region of said second hinge leaf for receiving said pintle, said second knuckle means being longitudinally aligned with said first knuckle means;
said pintle extends longitudinally through said first and said second knuckle means for enabling pivotal movement of said first hinge leaf relative to said second hinge leaf between respective hinge closed and hinge open configurations relative to said pintle,
the interrelationship between said first and said second hinge leaves being such that, when said hinge is in a closed configuration, said second hinge leaf is adjacent said second segment;
whereby, when said second leaf member is connected to said door by said mounting means, said hinge and said so connected said door can be suspended by said first leaf member at said aperture by said mounting means which extends through at least one of said longitudinally elongated holes and into said cabinet at a predetermined location.

2. The hinge of claim 1 wherein said second segment is of sufficient length and width to overlie an edge region of said side piece.

3. The hinge of claim 1 wherein said second segment has an opening medially defined therein, wherein said second hinge leaf has a reduced length in a region thereof adjacent to said second pintle means, and wherein the interrelationship between said first and said second hinge leaves is such that when said hinge is in said closed configuration, said region of second hinge leaf is received in said opening.

4. The hinge of claim 1 wherein said first hinge leaf further comprises a third respective progressive interconnected flattened segment that extends perpendicularly relative to said second segment and parallel relative to said first segment, and said third segment includes said first knuckle means located along an outer edge region of said third segment and extending parallel to said second segment.

5. The hinge of claim 4 wherein said third segment overlies said back side edge and has sufficient width to space said first knuckle means outwardly relative to said outside face when said hinge is in said closed position.

6. The hinge of claim 4 wherein said second hinge further comprises progressive, interconnected first and second respective flattened portions,
said first portion defining first and second transversely adjacent regions, said second region being adjacent to said second portion and having a reduced length relative to said first region, and said first region having holes defined therethrough for receipt therethrough of mounting means;
said second portion extending perpendicularly relative to said first portion, and said second portion being of sufficient length and width to overlie said back said edge,
said second portion including said second knuckle means for receiving said pintle, said second knuckle means being located along an edge region of said second segment and extending parallel to said first segment, said second knuckle means being longitudinally aligned with said first knuckle means;
the interrelationship between said first and said second hinge leaves being such that when said hinge is in said closed configuration said second portion is adjacent said third segment, and said second region is received within said opening.

7. The hinge of claim 1 wherein said first knuckles means comprises three knuckles and said second knuckle means comprises two knuckles that are interdigitated between said three knuckles.

8. The hinge of claim 1 wherein each of said first and said second hinge leaves additionally has hole means defined therethrough for receipt therethrough of mounting means.

9. The hinge of claim 8 wherein said mounting means comprises screw members each of which has a threaded shank portion of generally uniform diameter, and wherein each said hole means is threadably preliminarily associated with an outer end region of said threaded shank portion.

10. The hinge of claim 1 wherein said second hinge leaf includes at least two longitudinally separated holes that are each transversely elongated and adapted for receipt therethrough of mounting means whereby said transversely elongated holes in said second hinge leaf coact with said longitudinally elongated holes in said first hinge leaf so that said hinge is adjustably positionable relative to said mounting means that are so received through said holes.

11. The hinge of claim 1 wherein said mounting means comprise screw members, and at least some of said holes in each of said first and said second hinge leaves are each adapted to receive therethrough and matingly engage at least portions of the threaded shank of a screw member, whereby said holes can be preliminarily associated with said screw members before each of said first and said second hinge leaves is mounted.

12. A hinge adapted for use in hinging a cabinet door relative to an aperture in a cabinet for swinging movements of said door between open and closed hinge positions relative to said aperture, said door having respective inside and outside faces and a back side edge, said cabinet including a side piece means located along said aperture and adjacent said back side edge, said hinge comprising:
a hinge pintle;
a first hinge leaf comprising progressive, interconnected first, second and third respective flattened segments,
said first segment having defined therein at least two longitudinally separated holes that are each longitudinally elongated and adapted for receipt therethrough of mounting means,
said second segment extending perpendicularly relative to said first segment, said second segment being of sufficient length and width to overlie an edge region of said side piece, and said second segment having an opening medially defined therein;
said third segment extending perpendicularly relative to said second segment and parallel relative to said first segment,
said third segment including first knuckle means for receiving said pintle, said first knuckle means being located along an outer edge region of said third segment and extending parallel to said second segment,
said third segment being of sufficient length to overlie said back side edge and being of sufficient width to space said first knuckle means outwardly relative to said outside face when said hinge is in said closed position,
a second hinge leaf comprising progressive, interconnected first and second respective flattened portions
said first portion defining first and second transversely adjacent regions, said second region being adjacent to said second portion and having a reduced length relative to said first region, and said first region having holes defined therethrough for receipt therethrough of mounting means;
said second portion extending perpendicularly relative to said first portion, and said second portion being of sufficient length and width to overlie said back side edge,
said second portion including second knuckle means for receiving said pintle, said second knuckle means being located along an edge region of said second segment and extending parallel to said first segment, said second knuckle means being longitudinally aligned with said first knuckle means;
said pintle extends longitudinally through said first and said second knuckle means for enabling pivotal movement of said first hinge leaf relative to said second hinge leaf about said pintle,
the interrelationship between said first and said second hinge leaves being such that when said hinge is in a closed configuration
said second portion is adjacent said third segment, and
said second region is received within said opening;
whereby, when said when said second leaf member is connected to said door by said mounting means, said hinge and the so associated said door can be suspended by said first leaf member by said mounting means which extends through at least one of said longitudinally elongated holes and into said cabinet at a predetermined location.

13. The hinge of claim 12 wherein said first knuckle means comprises three knuckles and said second knuckle means comprises two knuckles that are interdigitated between said three knuckles.

14. The hinge of claim 12 wherein said longitudinally elongated holes in said first segment are each adapted to receive therethrough and threadably matingly engage at least portions of the threaded shank of a screw member.

15. The hinge of claim 12 wherein said second region has at least one hole defined therethrough for receipt therethrough of mounting means.

16. The hinge of claim 12 wherein said second portion has at least one hole defined therethrough for receipt therethrough of mounting means.

17. The hinge of claim 12 wherein at least some of said holes in said second leaf are elongated so as to permit said hinge to be adjustably positioned relative to said mounting means that are so received through said holes.

18. The hinge of claim 12 wherein at least some of the holes in said second leaf are each adapted to receive therethrough and threadably engage matingly at least portions of the threaded shank of a screw member.

19. The method of hinging a cabinet door relative to a cooperating aperture defined in a cabinet with a hinge as defined in claim 12 said method comprising the steps of:
(a) selecting an approximate location on each of said door and said cabinet adjacent to said aperture where each of said second leaf and said first leaf, respectively, of said hinge is to be mounted;
(b) drilling in said cabinet adjacent to said aperture a hole adapted for threadable engagement with a headed fastening member, said hole being aligned with a predetermined one of said longitudinally elongated holes in said first segment,
(c) preliminarily threadably associating a headed fastening screw member with said predetermined one longitudinally elongated hole in said first segment,
(d) mounting said second hinge leaf to said cabinet door at said selected location employing a plurality of headed fastening members that each extend through a different respective hole defined in said second hinge leaf, thereby to engage with said second hinge leaf with said cabinet door;
(e) locating said first hinge leaf at about said selected location at said cabinet and threadably advancing said so associated headed mounting screw member into said so-drilled hole to an extent sufficient to position and support said first hinge leaf and components associated therewith at said selected location at said cabinet, and
(f) mounting said first hinge leaf to said cabinet with headed-fastening members that each extend through a different respective hole defined in said first hinge leaf with said first hinge leaf being so positioned and supported relative to said cabinet.

20. The method of claim 19 wherein said headed-fastening members comprise screws.

21. The method of claim 20 wherein said screws extend into pre-drilled receiving holes defined in said cabinet door and said cabinet.

22. The method of claim 19 wherein said second hinge leaf is so mounted to said cabinet by said headed fastening members that extend into pre-drilled receiving holes defined in said cabinet.

23. The method of claim 19 wherein, after said second hinge leaf is so mounted, said so advanced said headed mounting screw member is further advanced until engaged with said first segment.
